(19) United States
(12) Patent Application Publication
(10) Pub. No.: US 2009/0291861 A1
(43) Pub. Date: Nov. 26, 2009

(54) WELLBORE FLUID

(76) Inventor: Christopher Alan Sawdon, Cornwall (GB)

Correspondence Address: NIXON & VANDERHYE, PC, 901 NORTH GLEBE ROAD, 11TH FLOOR, ARLINGTON, VA, 22203, US

(21) Appl. No.: 12/309,928

(22) PCT Filed: Aug. 2, 2007
(86) PCT No.: PCT/GB2007/002947

§ 371 Date: Feb. 3, 2009

(30) Foreign Application Priority Data
Aug. 7, 2006 (EP) 06254139.6

(51) Int. Cl. C09K 8/08

(52) U.S. Cl. 507/110

(57) ABSTRACT

There is provided a wellbore fluid comprising a polymeric saccharide having a number average molecular weight of not more than 50,000 which is a fructan or a partially-hydrolysed fructan or partially-hydrolysed starch, said fructan of partially-hydrolysed fructan or partially-hydrolysed starch having been modified by the introduction of one or more groups having the formula R—NH—CO— and/or R—CO—, wherein R represents a group having 4 to 32 carbon atoms.

The present invention relates to a wellbore fluid, for example, a drilling fluid, completion fluid, workover fluid or packer fluid.

Conventionally, the drilling of a well into the earth by rotary drilling techniques, involves the circulation of a drilling fluid from the surface of the earth down a drill string having a drill bit on the lower end thereof and through ports provided in the drill bit to the well bottom and thence back to the surface through the annulus formed about the drill string. The drilling fluid serves to cool the drill bit, to transport drill cuttings to the surface, and to stabilize the wellbore.

A problem often encountered in the drilling of a well is the loss of unacceptably large amounts of drilling fluid into subterranean formations penetrated by the well. This problem is often referred to generally as “lost circulation”, and the formations into which the drilling fluid is lost are often referred to as “lost circulation zones” or “thief zones”. Various causes may be responsible for the lost circulation encountered in the drilling of a well. For example, a formation penetrated by the well may exhibit unusually high permeability or may contain fractures or crevices therein. In addition, a formation may simply not be sufficiently competent to support the pressure applied by the drilling fluid and may break down under this pressure and allow the drilling fluid to flow thereinto.

An additional problem associated with drilling through a high permeability formation using a drill bit attached to the lower end of a drill string is that occasionally the drill string becomes stuck and cannot be raised, lowered or rotated. There are numerous causes for this problem, one of the most common being differential sticking. Differential sticking usually occurs when drilling through a permeable formation where the borehole pressure is greater than the formation pressure and when the drill pipe remains at rest against the wall of the borehole for enough time to allow a filter cake comprised of drilling fluid solids to build up around the pipe. The pressure exerted by the drilling fluid then holds the pipe against the filter cake. A reduction in fluid loss from a drilling fluid would reduce the thickness of the filter cake, thus reducing the incidence of differential sticking.

Damage (productivity loss) is caused by the invasion of fluids into producing formations associated with the loss of filtrate from drilling fluids and from other types of wellbore fluids such as completion fluids, workover fluids and packer fluids. It would therefore be desirable to reduce the fluid loss from a wellbore fluid into a subterranean formation, in particular, the fluid loss from a drilling fluid into a subterranean formation.

Wellbore fluid compositions, in particular drilling fluid compositions are known to be flowable systems that are generally thickened to a limited extent Environmental considerations tend to favour the use of purely aqueous based wellbore fluids, or aqueous based wellbore fluids of the oil-in-water emulsion type in which the oil phase is distributed as a heterogeneous fine dispersion in a continuous aqueous phase. Oil-based fluids, including the so-called invert emulsion fluids which are emulsions of the water-in-oil type in which the aqueous phase is distributed as a heterogeneous fine dispersion in the continuous oil phase, may however also be used.

Wellbore fluids often contain polymers performing various functions. Polymers are commonly added in order to modify the various properties of the fluid, for example, to increase the viscosity of the fluid. US 2005/1055796 discloses that the permeability of a subterranean formation to aqueous-based fluids during the drilling phase can be reduced by the use of a hydrophobically modified polymer comprising polar heteroatoms. Suitable polymers include hydrophobically modified starches.

We have now found that, by use of a particular type of polymer, generally disclosed in US 2003/0125482 and US 2004/0248761 for uses unconnected with the oil industry, significant improvement in fluid loss can be obtained.

Accordingly the present invention provides a wellbore fluid comprising a polymeric saccharide having a number average molecular weight of not more than 50,000 which is a fructan or a partially-hydrolysed fructan or partially-hydrolysed starch, said fructan or partially-hydrolysed fructan or partially-hydrolysed starch having been modified by the introduction of one or more groups having the formula R—NH—CO— and/or R—CO—, wherein R represents a group having 4 to 32 carbon atoms.

The hydrophobically modified polymeric saccharides used in the present invention may be represented by the general formula (I)

[A]ₙ[(-M)ₛ]ₙ (I)

wherein

[A]ₙ represents a fructan-type polysaccharide in which [A] represents a fructosyl unit or a terminal glucosyl unit, or a starch-type polysaccharide in which [A] represents a glucosyl unit;

n represents the number of fructosyl and glucosyl units in said polysaccharide;

(-M) represents a hydrophobic group that substitutes a hydrogen atom of a hydroxyl group of said fructosyl and/or glucosyl units, said group having the formula R—NH—CO— or R—CO—, wherein R represents a group having 4 to 32 carbon atoms;

and s represents the average number of hydrophobic groups substituted onto each fructosyl or glucosyl unit.

In the formula I, n may be referred to the degree of polymerisation of the polysaccharide, DP, while s may be referred to as the number average degree of substitution (av. DS). These parameters influence the molecular weight: it is a requirement of the present invention that the polymeric saccharide should have a number average molecular weight of not more than 50,000, preferably not more than 20,000, especially not more than 10,000. Preferably, the polymeric saccharide has a number average molecular weight of at least 1,000.

As mentioned above, US 2005/1055796 discloses that the permeability of a subterranean formation to aqueous-based fluids during the drilling phase can be reduced by the use of a hydrophobically modified polymer comprising polar heteroatoms. Suitable polymers include hydrophobically modified starches. Such reduction in permeability, which is to do with the relative permeability of oil and water within a formation (so-called “conformance control”) is a quite different effect from the reduction in fluid loss from a wellbore, i.e. the reduction in the filtration rate of a wellbore fluid, obtained by the present invention. It is surprising that the polymeric saccharides used in the present invention, which have a relatively low molecular weight compared with the materials used in the process of US 2005/1055796, can produce this effect.

The compounds used in the present invention are known. They may for example be derived by appropriate substitution from homodisperse or polydisperse, linear or branched fructan-type polysaccharides selected from inulin, oligofructose, fructo-oligosaccharide, partially hydrolysed inulin, levan, and partially hydrolysed levan, or starch hydrolysates, by the substitution of the hydrogen atom of one or more of the hydroxyl groups of the fructosyl and/or glucosyl units by a hydrophobic moiety [M] defined above.

Inulin mainly consists of fructosyl units that are bound to one another by β (2-1) fructosyl-fructosyl bounds, and possibly having a terminal glucosyl unit. It is synthesised by various plants as a reserve carbohydrate, by certain bacteria, and can also be synthetically obtained through an enzymatic process from sugars containing fructose units, such as sucrose. Very suitable in accordance with the present invention is polydisperse, linear inulin or slightly branched inulin (typically inulin having a branching that is below 20%, preferably below 10%) from plant origin with a DP ranging from 3 to about 200, preferably from 3 to about 100.

Very suitable inulin is chicory inulin that has a DP ranging from 3 to about 70. Even more suitable is chicory inulin that has been treated to remove most monomeric and dimeric saccharide side products, and that has optionally also been treated to remove inulin molecules with a lower DP, typically a DP from 3 to about 9, typically raising the average DP above 10.

Said grades of chicory inulin can be obtained from roots of chicory by conventional extraction, purification and fractionation techniques, as for example disclosed in U.S. Pat. No. 4,285,735, in EP 0 670 850 and in EP 0 769 026. They are commercially available for example from ORAFTI, Belgium as RAFTILINE® ST (standard grade chicory inulin with av. DP of 10-13), RAFTLINE® LS (standard grade chicory inulin with an av. DP of 10-13, and with in total less than 0.5 wt % (on dry substance) of monomeric and dimeric saccharides) and RAFTILINE® HP (high performance grade chicory inulin, with an average DP of about 23 which contains only minor amount of monomeric saccharides, dimeric saccharides and inulin molecules with a DP from 3 to about 9).

Further suitable polysaccharides of the fructan-type include partially hydrolysed inulin and inulin molecules with a DP ranging from 3 to about 9, namely oligofructose and fructo-oligosaccharide (i.e. oligofructose molecules with an additional terminal glucosyl unit). Said saccharides are known in the art. Typically suitable products are obtained by partial, enzymatic hydrolysis of chicory inulin, for example as disclosed in EP 0 917 588. They are commercially available, for example as RAFTILOSE® P95 from ORAFTI, Belgium.

Further suitable polysaccharides of the fructan-type are levans and partially hydrolysed levans, molecules mainly consisting of fructosyl units that are bound to each other by β (2-6) fructosyl-fructosyl bounds and may have a terminal glucosyl unit.

Starches and starch hydrolysates are polymeric saccharides consisting of D-glucosyl units which are inked to one another. In starch the glucosyl units are typically linked by α-1,4-glucosyl-glucosyl bounds, forming linear molecules, named amylose, or by α-1,4- and α-1,6 glucosyl-glucosyl bounds; forming branched molecules, named amylopectin.

The linkages between the glucosyl units in starch-type molecules are sensitive to disruption. This phenomenon is industrially exploited to prepare modified starches (commonly named dextrins) and starch hydrolysates from starch through thermal treatment commonly in the presence of a catalyst, through acidic hydrolysis, enzymatic hydrolysis, or shearing, or through combinations of such treatments. Depending on the source of the starch and the reaction conditions, a wide variety of modified starches and starch hydrolysates can be prepared at industrial scale by conventional methods.

Starch occurs in nature as a polydisperse mixture of polymeric molecules which have, depending on the plant source, mainly a linear structure or mainly a branched structure. Starch can also occur in nature as a polydisperse mixture of molecules with said structures. The DP, i.e. the number of glucosyl units linked to one another in a starch molecule, may widely vary and it largely depends on the plant source and the harvesting time. The present invention may be carried out using polymeric saccharides derived from partially-hydrolysed starches in which the DP of the parent starch has been reduced to the desired level. Starch hydrolysates conventionally refer to polydisperse mixtures composed of D-glucose, oligomeric (DP 2 to 10) and/or polymeric (DP>10) molecules composed of D-glucosyl chains. Starch hydrolysates are differentiated by means of a dextrose equivalent (D.E.) which formally corresponds to the grams of D-glucose (dextrose) per 100 grams of dry substance. D-glucose having a D.E. of 100, the D.E. indicates the amount of D-glucose and reducing sugar units (expressed as dextrose) in a given product on dry product basis. Starch hydrolysates may range from a product essentially composed of glucose, over products with a D.E. greater than 20 (commonly named glucose syrup), to products with a D.E. of 20 or less (commonly named maltodextrins).

Starch hydrolysates that are very suitable polysaccharides for the preparation of hydrophobically modified polysaccharides for use in the present invention, include those having a D.E. ranging from 2 to 47, for example from 2 to 20. They may be obtained by conventional processes from various starch sources, for example corn, potato, tapioca, rice, sorghum and wheat.

Starch hydrolysates are commercially available. Typically suitable starch hydrolysates for use in the preparation of compounds useful in the present invention are for example GLUCIDEX® maltodextrins and GLUCIDEX® dried glucose syrups which are available from ROQUETTE company, such as the maltodextrins of type 1 (potato based with D.E. max 5), type 2 (Waxy Maize based with D.E. max 5), type 6 (Waxy Maize based with D.E. 5 to 8), type 9 (Potato based with D.E. 8 to 10), and maltodextrins of type 12 (D.E. 11 to 14), type 17 (D.E. 15 to 18) and type 19 (D.E. 18 to 20), as well as dried glucose syrups of type 21 (D.E. 20 to 23), type 28E (D.E. 28 to 31), type 29 (D.E. 28 to 31), type 32 (D.E. 31 to 34), type 33 (D.E. 31 to 34), type 38 (D.E. 36 to 40), type 39 (D.E. 38 to 41), type 40 (D.E. 38 to 42) and type 47 (D.E. 43 to 47).

R has from 4 to 32 carbon atoms. It may be linear or branched. Preferably, it is a linear hydrocarbyl radical with 6 to 20 carbon atoms, more preferably with 6 to 18 carbon atoms, most preferably with 8 to 12 carbon atoms. Said group may for example be an alkyl, alkenyl or alkynyl group. In a preferred embodiment R is a linear alkyl or mono-unsaturated alkenyl group with 6 to 18 carbon atoms. Typical suitable alkyl groups include butyl, hexyl, octyl, decyl, dodecyl, tetradecyl, hexadecyl and octadecyl groups, while alkenyl groups include hexenyl, octenyl, decenyl, dodecenyl, tetradecenyl, hexadecenyl and octadecenyl groups. Two or more of the same or different groups R—NH—CO— and/or R—CO—, in which each R group can be the same or different, may be present in the compounds used in the present invention.

Each of the fructosyl and glucosyl units of said polymeric saccharide molecules has a maximum of two, three or four hydroxyl groups of which the hydrogen atom can be substituted by a said hydrophobic moiety, depending respectively on whether the unit is at a branching point of the polysaccharide chain, is a unit of a linear part of the chain or is a terminal unit of the chain. Since the DS (s in formula (I)) represents an average number of substituents per fructosyl or glucosyl unit, there may be fructosyl or glucosyl units present which are not substituted by a hydrophobic group. The positions on the fructosyl or glucosyl units where the hydrophobic substituents are located are not critical with respect to the present invention.

The av. DS, s of formula (I), suitably ranges from 0.01 to 2, preferably from 0.02 to 1.5, more preferably from 0.05 to 1. In general, s of a compound of formula I for use in an oil-based fluid is preferably in the range of from 0.2 to 2, more preferably 0.4 to 1.5, especially from 0.5 to 1, while s of a compound of formula I for use in a water-based fluid is preferably in the range of from 0.01 to 0.5, more preferably from 0.02 to 0.4, especially from 0.05 to 0.35.

As stated above, the hydrophobically modified polysaccharides are known in the art and can be prepared by conventional methods, for example as described in US 2004/0248761.

The concentration of the polymeric saccharide in the wellbore fluid according to the invention is not critical, and may for example be from 0.1 to 20% by weight based on the total weight of the oil and/or water present, in the absence of any weighting agents or other constituents of the fluid. Preferably however, for economic and rheological reasons, a relatively low content of polymeric saccharide is used. When the fluid is an oil-in-water emulsion, the content of polymeric saccharide is preferably from 0.1 to 8 percent by weight, preferably 0.5 to 6 percent by weight, whereas when the fluid is purely water based, the content of polymeric saccharide is preferably from 0.1 to 10 percent by weight, preferably 0.5 to 8 percent by weight. Similarly, when the fluid is a water-in-oil emulsion, the content of polymeric saccharide is preferably from 0.1 to 8 percent by weight, preferably 0.5 to 6 percent by weight, whereas when the fluid is purely oil based, the content of polymeric saccharide is preferably from 0.1 to 10 percent by weight, preferably 0.5 to 8 percent by weight.

If desired, two or more polymeric saccharides may be present.

The fluid of the invention may be either a purely aqueous- or purely oil-based fluid, or an oil-in-water or water-in oil emulsion. Preferably, the fluid is a purely aqueous-based fluid or is an oil-in-water emulsion—i.e. it is a fluid in which the continuous phase is water. The polymeric saccharides used in the invention, having both hydrophilic and hydrophobic units, will have emulsifier and surfactant properties. In the case of an emulsion, the polymeric saccharide tends to act as an emulsifier, and stabilises the droplets of the discontinuous phase in the continuous phase. Minor amounts of at least one conventional emulsifier may additionally be present if desired, but preferably the polymeric saccharide is the only emulsifier or surfactant present in the fluid of the invention, whether the fluid is an emulsion or an entirely aqueous or oil-based system. Suitable conventional emulsifiers would be well known to the person skilled in the art.

Typically, the wellbore fluid is a drilling fluid, completion fluid, workover fluid or packer fluid, preferably a drilling fluid. Incorporation of the polymeric saccharide leads to reduced fluid loss when using the wellbore fluids of the invention. Fluid loss may be determined using a high temperature high pressure (HTHP) fluid loss test, according to the specifications of the American Petroleum Institute (API) as detailed in “Recommended Practice Standard Procedure for Field Testing Water-Based Drilling Fluids”, API Recommended Practice 13B-1 Second Edition, September 1997, Section 5.3.1 to 5.3.2. The test employs a pressurized cell fitted with a standard hardened filter paper as a filtration medium. The filtration area is 7.1 square inches (0.0045 m²) or may be smaller. If smaller, the result reported is corrected to a filter area of 7.1 square inches. For instance the filtrate volume using a 3.55 square inches (0.0023 m²) filter area is doubled to provide the corrected result. Generally, the filtration behaviour of the wellbore fluid in the HTHP test is determined with a pressure differential across the filter paper of 500 psi (3.45×10⁶ Pa). Suitably, the temperature at which the HTHP fluid loss test is carried out may be varied to correspond to the downhole temperature. Generally, the test temperature is in the range 50 to 150° C. A filter cake is allowed to build up on the filter paper for 30 minutes and the volume of filtrate collected during this 30 minute period is then recorded.

Preferably, the polymeric saccharide is incorporated in the wellbore fluid according to the invention in an amount effective to achieve an HTHP fluid loss value, when the test is performed at a temperature of 250° F. (121° C.) and a differential pressure of 500 psi (3.45×10⁶ Pa), of less than 20 ml/30 minutes, preferably less than 15 ml/30 minutes, more preferably less than 10 ml/30 minutes. An advantage of the wellbore fluid of the present invention is that the reduced invasion of the fluid into the formation decreases formation damage.

Where the fluid of the invention takes the form of an oil-based fluid or an emulsion, the oil may for example be a crude oil, a refined petroleum fraction, a mineral oil, a synthetic hydrocarbon, or any suitable non-hydrocarbon oil. In the case of an emulsion, any non-hydrocarbon oil that is capable of forming a stable emulsion with the aqueous phase may be used. Preferably, such a non-hydrocarbon oil is biodegradable and is therefore not associated with ecotoxic problems. It is particularly preferred that such a non-hydrocarbon oil has a solubility in water at room temperature of less than 2% by weight, preferably, less than 1.0% by weight, most preferably, less than 0.5% by weight.

In an emulsion, the discontinuous phase, preferably an oil, is for example dispersed in the continuous phase, preferably water, in an amount of from 1 to 65% by volume, preferably 2.5 to 40% by volume, most preferably 10 to 35% by volume based on the total volume of the aqueous and oil phases. Generally, the discontinous phase is distributed in the continuous phase in the form of finely divided droplets. Suitably, the droplets have an average diameter of less than 40 microns, preferably between 0.5 and 20 microns, and most preferably between 0.5 and 10 microns.

Suitably, the oil may be a non-hydrocarbon oil selected from the group consisting of polyalkylene glycols, esters, acetals, synthetic hydrocarbons, ethers and alcohols.

Suitable polyalkylene glycols include polypropylene glycols (PPG), polybutylene glycols, and polytetrahydrofurans. Preferably, the molecular weight of the polyalkylene glycol should be sufficiently high that the polyalkylene glycol has a solubility in water at room temperature of less than 2% by weight. The polyalkylene glycol may also be a copolymer of at least two alkylene oxides. Suitably, ethylene oxide may be employed as a comonomer provided that the mole percent of units derived from ethylene oxide is limited such that the solubility of the copolymer in water at room temperature is less than 2% by weight. The person skilled in the art would be able to readily select polyalkylene glycols that exhibit the desired low-water solubility.

Suitable esters include esters of unsaturated fatty acids and saturated fatty acids as disclosed in EP 0374671A and EP 0374672 respectively; esters of neo-acids as described in WO 93/23491; oleophilic carbonic acid diesters having a solubility of at most 1% by weight in water (as disclosed in U.S. Pat. No. 5,461,028); triglyceride ester oils such as rapeseed oil (see U.S. Pat. No. 4,631,136 and WO 95/26386. Suitable acetals are described in WO 93/16145. Suitable synthetic hydrocarbons include polyalphaolefins (see, for example, EP 0325466A, EP 0449257A, WO 94/16030 and WO 95/09215); isomerized linear olefins (see EP 0627481A, U.S. Pat. No. 5,627,143, U.S. Pat. No. 5,432,152 and WO 95/21225); n-paraffins, in particular n-alkanes (see, for example, U.S. Pat. No. 4,508,628 and U.S. Pat. No. 5,846,913); linear alkyl benzenes and alkylated cycloalkyl fluids (see GB 2,258,258 and GB 2,287,049 respectively). Suitable ethers include those described in EP 0391251A (ether-based fluids) and U.S. Pat. No. 5,990,050 partially water-soluble glycol ethers). Suitable alcohols include oleophilic alcohol-based fluids as disclosed in EP 0391252A.

Preferably the fluid according to the invention is an oil-in-water emulsion or, especially, an entirely water-based system. In the latter case, the carrier fluid comprises a solution of the polymeric saccharide in water, insubstantial amounts, or no, oil being present.

Water in the fluid of the invention may be fresh water, brackish water, seawater, or a synthetic brine containing one or more salts. As would be well known to the person skilled in the art, the salt should be compatible with the polymeric saccharide, for example, should not form an insoluble precipitate with the polymer. Suitable salts include alkali metal halides, alkali metal carbonates, alkali metal sulphates, alkali metal formates, alkali metal phosphates, alkali metal silicates, alkaline earth metal halides, and zinc halides. The salt may be present in the aqueous solution at concentrations up to saturation. Preferably, the salt in a brine is present at a concentration in the range 0.5 to 25% by weight, for example, in the range 3 to 15% by weight, based on the total weight of the brine.

Suitably, the specific gravity of the wellbore fluid is in the range 0.9 to 2.5, typically in the range 1.0 to 2.0.

Preferably, the wellbore fluid additionally comprises at least one additional fluid loss control agent. As would be well known to the person skilled in the art, the fluid loss from a wellbore fluid, especially a drilling fluid, may be reduced to some extent by incorporating conventional fluid loss control agents in the fluid. Suitable known fluid loss control agents that may be incorporated in the fluid of the present invention include organic polymers of natural and/or synthetic origin. Suitable polymers include starch or chemically modified starches other than the polymeric saccharide; cellulose derivatives such as carboxymethylcellulose and polyanionic cellulose (PAC); guar gum and xanthan gum; homopolymers and copolymers of monomers selected from the group consisting of acrylic acid, acrylamide, acrylamido-2-methyl propane sulfonic acid (AMPS), styrene sulphonic acid, N-vinyl acetamide, N-vinyl pyrrolidone, and N,N-dimethylacrylamide wherein the copolymer has a number average molecular weight of from 100,000 to 1,000,000; asphalts (for example, sulfonated asphalts); gilsonite; lignite (humic acid) and its derivatives; lignin and its derivatives such as lignin sulfonates or condensed polymeric lignin sulfonates; and combinations thereof. Any of these polymers that contain acidic functional groups are preferably employed in the neutralised form e.g. as sodium or potassium salts. As an alternative to, or in addition to, employing such additives, the fluid loss when using a drilling fluid may be reduced by adding finely dispersed particles such as clays (for example, illite, kaolinite, bentonite, hectorite or sepiolite) to the fluid. Without wishing to be bound by any theory, it is believed that a filter cake comprised of fluid loss additives and/or finely divided clay particles will build up on the wellbore wall and/or will bridge fractures present in the wellbore wall. These fractures may be naturally occurring or may be induced during the drilling of the wellbore. It is believed that the filter cake will additionally comprise fluid droplets and other solids that are present in the drilling fluid such as drill cuttings.

Preferably, a bridging particulate material is added to a drilling fluid of the present invention in order to assist in the formation of a filter cake and to assist in bridging the fractures. Suitably, the bridging particulate material comprises at least one substantially crush resistant particulate solid. Preferred bridging particulate materials for adding to the fluid include graphite, calcium carbonate, celluloses, micas, proppant materials such as sands or ceramic particles and combinations thereof. These materials are very inert and are environmentally acceptable. Suitably, the bridging particulate material is sized so as not to enter the pores of any permeable rock through which the wellbore is being drilled. Typically, the bridging material has an average particle diameter in the range 25 to 2000 microns, preferably 50 to 1500 microns, more preferably 250 to 1000 microns. The bridging material may comprise substantially spherical particles. However, it is also envisaged that the bridging material may comprise elongate particles, for example, fibres. Preferably, the bridging material has a broad (polydisperse) particle size distribution.

Finely-dispersed additives for increasing the fluid density may also be incorporated. Suitable additives for increasing the fluid density include barium sulfate (barite), calcium carbonate (calcite), the mixed carbonate of calcium and magnesium (dolomite), hematite and mixtures thereof.

Optionally, the fluid of the present invention may comprise thinners (dispersants) for viscosity regulation. So-called thinners can be of organic or inorganic nature; examples of organic thinners are tannins and/or quebracho extract Further examples are lignin and lignin derivatives, particularly lignosulfonates. Other useful dispersants include synthetic water-soluble polyanionic polymers such as sodium polyacrylate having a number average molecular weight, Mₙ, in the range 1,000 to 100,000, preferably 5,000 to 50,000. Polyphosphate compounds are examples of inorganic thinners. Of course, thinners may have a dual function acting both as a thinner and a fluid loss additive. Thus, the thinner (dispersant) may act by dispersing the solids contained in a drilling fluid which assists in the formation of a low permeability filter cake thereby reducing fluid loss. The thinner may also act directly to reduce fluid loss if it has a colloidal component.

Preferably, the plastic viscosity of the fluid of the present invention is in the range 1 to 100 mPa·s. Preferably, the yield point is between 2 and 50 Pa.

Optionally, the fluid composition, especially a drilling fluid, may comprise additives which inhibit undesired water-exchange with, for example, clays. Any of the known additives for use in drilling fluids may be employed. Suitable additives include halides, formates, sulphates, phosphates, carbonates and silicates of the alkali metals, or the halides of the alkaline earth metals and zinc, with particular importance given to potassium salts, optionally in combination with lime. Reference is made, for example, to the appropriate publications in “Petroleum Engineer International”, September 1987, 32-40 and “World Oil”, November 1983, 93-97. As would be well known to the person skilled in the art, other so-called shale inhibitors may be added to the drilling fluid to stabilise clays and shales including polyacrylamides and polyamines.

The quantity of auxiliary substances and additives used in each case lie within the usual boundaries for a drilling fluid.

An advantage associated with a drilling fluid of the present invention is that the low fluid loss may strengthen the wellbore wall by the solids contained therein bridging cracks and fissures thereby increasing the hoop stress. A further advantage of the drilling fluid is that the reduction in the fluid loss reduces the filter cake thickness thereby reducing the incidence of differential sticking.

According to a further embodiment of the present invention there is provided a method of carrying out a wellbore operation using a circulating wellbore fluid, the method comprising circulating in the wellbore a wellbore fluid according to the invention. A still further embodiment provides the use of a polymeric saccharide having a number average molecular weight of not more than 50,000 which is a fructan or a partially-hydrolysed fructan or starch, said fructan or partially-hydrolysed fructan or starch having been modified by the introduction of one or more groups having the formula R—NH—CO— and/or R—CO—, wherein R represents a group having 4 to 32 carbon atoms, as a fluid-loss control agent in a wellbore operation.

The fluid of the present invention may also be employed in the method of reducing formation breakdown during the drilling of a wellbore through a formation with a circulating drilling fluid that is described in WO 2005/012687 which is herein incorporated by reference. Thus, the drilling fluid that is circulating in the wellbore is preferably selected so as to have a fluid loss value of less than 2 ml/30 minutes (measured according to the high temperature high pressure API fluid loss test described in WO 2005/012687. Prior to encountering formation breakdown, a solid particulate material having an average particle-diameter of 25 to 2000 microns is added to the drilling fluid in a concentration of at least 0.5 pounds per barrel, preferably at least 10 pounds per barrel, more preferably, at least 15 pounds per barrel. Thereafter drilling is continued through the formation with the pressure in the wellbore maintained at above the initial fracture pressure of the formation.

The present invention will now be illustrated by reference to the following Examples. In the Examples, the following materials were used:

Inutec SP1t (Trade Mark; obtainable from Orafti). This polymer is an Inulin polysaccharide (polyfructose) grafted with long chain alkyl groups.
K₂HPO₄: di potassium hydrogen phosphate (ex Aldrich).
PPG 2000: polypropylene glycol; average molecular weight (Mn) 2000.
Duovis® Xanthan gum, ex Schlumberger.
Drill-Thin™: a powdered dispersant, ex Drilling Specialties Inc. that contains 70+% sulphomethylated quebracho.
Hymod Prima (HMP): a powdered ball clay ex Imerys Minerals Ltd. This clay was used to replicate dispersed clay solids that accumulate in a drilling mud when drilling through clay-rich sediments.
Barite: API grade (drilling fluid grade) barium sulphate powder, ex M-I Drilling Fluids UK Ltd.
Caustic Soda: used to adjust the final pH of the fluids where necessary.

In the Examples, the fluids were tested in accordance with the Recommended Practice of the American Petroleum Institute—API RP 13B-1: Recommended Practice Standard Procedure for Field Testing Water-Based Drilling Fluids

### EXAMPLE 1

### Emulsion-Free Fluids Having a Potassium Chloride Solution Aqueous Phase

The formulations shown in Table IA were mixed using a Silverson L4R mixer, and after mixing the resulting muds were placed into bombs and aged (hot rolled) for 16 hours (overnight) @ 93° C. The resulting properties after hot rolling are given in Table IB, and clearly show that Inutec SP1t is effective at reducing fluid loss.

TABLE IA

| Components (for 350 mls of | NO INUTEC | WITH INUTEC |
|---|---|---|
| final volume) | SP1t g | SP1t g |
| Dionised Water | 265 | 256 |
| Drill Thin ™ | 25 | 25 |
| KCl | 15 | 15 |
| INUTEC SP1t | — | 10 |
| Restore pH to 7 using NaOH | — | — |
| Duovis ™ | 0.35 | 0.35 |
| Hymod Prima ™ | 25 | 25 |
| Barite | 144 | 144 |
| Final pH adjusted to 7 using | — | — |
| NaOH | | |

TABLE IB

| | NO INUTEC | WITH INUTEC |
|---|---|---|
| | SP1t | SP1t |
| Plastic Viscosity (cP) at 120° F. | 12 | 13 |
| (48.9° C.) | | |
| Yield Point (lb/100 sq. ft.) | 8 | 9 |
| 120° F. (48.9° C.) | | |
| API Fluid Loss (mls) | 10.2 | 3.0 |
| 100 psi (6.89 × 10⁶ Pa)/68° F. | | |
| (20° C.) | | |
| High temperature/High Pressure | 18.0 | 9.4 |
| (HTHP) Fluid Loss (mls) | | |
| 500 psi (3.45 × 10⁶ Pa)/250° F. | | |
| (121° C.) | | |

### EXAMPLE 2

### Emulsion-Free Fluid Having a Sodium Chloride Solution Aqueous Phase

The method of Example 1 was repeated using the same Inutec SP1t-containing formulation as in Example 1, except that the potassium chloride was replaced by sodium chloride. The results are shown in Table II. Again, Inutec SP1t is shown to be an effective additive.

TABLE II

| | |
|---|---|
| Plastic Viscosity (cP) at 120° F. (48.9° C.) | 13 |
| Yield Point (lb/100 sq. ft.) | 9 |
| 120° F. (48.9° C.) | |
| API Fluid Loss (mls) | 1.6 |
| 100 psi (6.89 × 10⁶ Pa)/68° F. (20° C.) | |
| High temperature/High Pressure | 7.6 |
| (HTHP) Fluid Loss (mls) | |
| 500 psi (3.45 × 10⁶ Pa)/250° F. (121° C.) | |

### EXAMPLE 3

### Drilling Fluid Having a Polypropylene Glycol 2000 Emulsion Phase and a Sodium Chloride Solution Aqueous Phase

The method of Example 1 was repeated using a formulation as shown in Table IIIA. The results are shown in Table IIIB. These results show that Inutec SP1t effectively stabilises the polypropylene glycol emulsion under saline high temperature conditions thereby further reducing fluid loss.

TABLE IIIA

| Components for 350 mls) | (g) |
|---|---|
| DI Water (g) | 230 |
| Drill Thin (g) | 25 |
| Over 20 minutes mixing, NaOH | 10.0 |
| added to stabilize pH at pH | |
| NaCl (g) | 15 |
| INUTEC SP1t | 10 |
| Duovis (g) | 0.35 |
| PPG 2000 (high shear mix for 20 | 27 |
| minutes) | |
| Hymod Prima (g) | 25 |
| Barite (g) | 144 |
| Final pH with NaOH adjusted to | 10.0 |

TABLE IIIB

| | |
|---|---|
| Plastic Viscosity (cP) at 120° F. (48.9° C.) | 19 |
| Yield Point (lb/100 sq. ft.) | 21 |
| 120° F. (48.9° C.) | |
| API Fluid Loss (mls) | 0.8 |
| 100 psi (6.89 × 10⁶ Pa)/68° F. (20° C.) | |
| High temperature/High Pressure | 3.6 |
| (HTHP) Fluid Loss (mls) | |
| 500 psi (3.45 × 10⁶ Pa)/250° F. (121° C.) | |

### EXAMPLE 4

### Drilling Fluid Having a Polypropylene Glycol 2000 Emulsion Phase and a Potassium Hydrogen Phosphate Solution Aqueous Phase

The method of Example 1 was repeated using a formulation as shown in Table IVA. The results are shown in Table IVB. These low filtration results show the versatility of this class of polymeric surfactant in a variety of ionic environments.

TABLE IVA

| Components for 350 mls | (g) |
|---|---|
| DI water | 246 |
| Drill Thin | 15 |
| pH to 10 (KOH) | |
| Mix for 15 mins | |
| K₂HPO₄ | 22 |
| Inutec SP1t | 13.5 |
| PPG 2000 | 27 |
| Mix at high shear for 20 minutes | |
| Duovis | 0.7 |
| HMP | 25 |
| Barite | 144 |
| Final pH with (KOH) | 10 |

TABLE IVB

| | |
|---|---|
| Plastic Viscosity (cP) at 120° F. (48.9° C.) | 15 |
| Yield Point (lb/100 sq. ft.) | 12 |
| 120° F. (48.9° C.) | |
| API Fluid Loss (mls) | 0.4 |
| 100 psi (6.89 × 10⁶ Pa)/68° F. (20° C.) | |
| High temperature/High Pressure | 3.6 |
| (HTHP) Fluid Loss (mls) | |
| 500 psi (3.45 × 10⁶ Pa)/250° F. (121° C.) | |

1.-15. (canceled)

16. A wellbore fluid comprising a polymeric saccharide having a number average molecular weight of not more than 50,000 which is a fructan or a partially-hydrolysed fructan or partially-hydrolysed starch, said fructan or partially-hydrolysed fructan or partially-hydrolysed starch having been modified by the introduction of one or more groups having the formula R—NH—CO— and/or R—CO—, wherein R represents a group having 4 to 32 carbon atoms.

17. A wellbore fluid as claimed in claim 16, in which the polymeric saccharide is derived from inulin.

18. A wellbore fluid as claimed in claim 17, in which the inulin has a degree of polymerisation ranging from 3 to about 200.

19. A wellbore fluid as claimed in claim 16, in which R is a linear hydrocarbyl radical having 6 to 20 carbon atoms.

20. A wellbore fluid as claimed in claim 19, in which R is a linear alkyl or mono-unsaturated alkenyl group having 6 to 18 carbon atoms.

21. A wellbore fluid as claimed in claim 16, in which the average degree of substitution of the polymeric saccharide is from 0.01 to 2.

22. A wellbore fluid as claimed in claim 21, which is an oil-based fluid in which the average degree of substitution of the polymeric saccharide is from 0.2 to 2.

23. A wellbore fluid as claimed in claim 21, which is a water-based fluid in which the average degree of substitution of the polymeric saccharide is from 0.01 to 0.5.

24. A wellbore fluid as claimed in claim 16, in which the concentration of the olymeric saccharide is from 0.1 to 20% by weight based on the total weight of the oil and/or water present in the fluid.

25. A wellbore fluid as claimed in claim 16, which comprises a solution of the polymeric saccharide in water, insubstantial amounts, or no, oil being present; or which is an oil-in-water emulsion.

26. A wellbore fluid as claimed in claim 24, which is an oil-in-water emulsion in which the oil is a crude oil, a refined petroleum fraction, a mineral oil, a synthetic hydrocarbon, or a non-hydrocarbon oil that is capable of forming a stable emulsion with water.

27. A wellbore fluid as claimed in claim 16, which additionally comprises at least one additional fluid loss control agent.

28. A wellbore fluid as claimed in claim 16, which has a plastic viscosity in the range 1 to 100 mPa·s.

29. A wellbore fluid as claimed in claim 16, which is a drilling fluid.

30. A method of carrying out a wellbore operation using a circulating wellbore fluid, the method comprising circulating in the wellbore a wellbore fluid as claimed in claim 29.
